(19) United States
(12) Patent Application Publication
(10) Pub. No.: US 2012/0261950 A1
(43) Pub. Date: Oct. 18, 2012

(54) VEHICLE ROOF SUPPORT ASSEMBLY

(75) Inventors: Jason Scott Balzer, Commerce Township, MI (US); Dustin Michael Hall, Novi, MI (US); Roman Grygosinski, Livonia, MI (US); Vince Chimento, Plymouth, MI (US); David Baerlin, Livonia, MI (US); Christopher L. Eikey, Howell, MI (US); Ryan Craig, Harrison Township, MI (US)

(73) Assignee: Ford Global Technologies, LLC, Dearborn, MI (US)

(21) Appl. No.: 13/085,706

(22) Filed: Apr. 13, 2011

(51) Int. Cl. B62D 25/04

(52) U.S. Cl. 296/193.05; 296/193.06; 296/209

(57) ABSTRACT

A vehicle roof support assembly is provided which includes a roof rail, a rocker panel, a first hollow support member and a second hollow support member. The first hollow support member and the second hollow support member each includes an inner wall, an outer wall, a front wall, a front wall and a rear wall. The first hollow support member and the second hollow support member each include a tubular lower area that extends upwardly from the rocker panel. The first hollow support member and the second hollow support member also each include an upper section that extends downwardly from the roof rail. The first hollow support member and the second hollow support member are spaced apart from one another in at least a middle area of the first and second hollow support members.

### BACKGROUND

The present disclosure relates generally to vehicle structures, and more particularly to a roof support assembly and side impact structure for a vehicle.

Roof support pillars support the roof of a vehicle and are located between the windows and doors of a vehicle. Roof support pillars are frequently identified as A, B, C and in some instances D-Pillars depending on the vehicle style. A B-Pillar is generally located immediately behind the front door of a vehicle and is traditionally used to mount the rear door hinges and associated rear doors. The B-Pillar is an important element in determining roof strength and the degree of side impact intrusion.

The roof support pillars for a vehicle may be manufactured using a tubular hydroforming process which is a metal-forming process in which a fluid is used to outwardly expand a tubular metal blank into conformity with surfaces of a die assembly cavity to form an individual hydroformed member. A tubular blank can be shaped during the hydroforming process to have a traverse cross-section that varies continuously along its length. Tubular hydroforming enables manufacturers to increase part stiffness, dimensional accuracy, fatigue life, and crashworthiness over non-hydroformed parts (such as stamped parts for example) while reducing part mass and cost.

Hydroformed components have a high strength relative to their mass (as compared to stamped sheet metal components for example), in part because of the plastic deformation of the wall of the blank which occurs during the hydroforming process. More particularly, the outward expansion of the tubular metallic wall of the blank during hydroforming caused by the fluid pressure within the blank creates a work-hardening effect which uniformly hardens the metallic material of the resulting hydroformed member. Hydroforming also produces less waste material than stamping. Hydroformed parts are relatively economical for vehicle manufacturers to produce because the tooling costs associated with hydroforming are typically lower than those associated with other manufacturing methods.

Passenger vehicle designs are tested for roof strength and side impact strength. Conventional B-Pillars are fabricated as multiple stamped sheet metal parts that are generally spot welded together. It is possible to improve the strength of conventional B-Pillars by forming the sheet metal parts from high grade material, such as dual phase and boron steels. B-Pillars may also be made stronger by using thicker gauge alloys and thicker sheet metal may increase the weight of a vehicle and also increase the cost to manufacture the B-Pillar. Even with the use of thicker ally components, B-Pillars of conventional design may not always meet stringent test requirements for roof strength and side impact performance.

It has been proposed to use hydroformed tubes to fabricate vehicles having space frame construction in, for example, U.S. Pat. No. 6,282,790. This patent proposes integrally forming two B-Pillars and a roof bow in a single U-shaped piece that is connected to the top surface of two tubular rockers. This proposed design presents a manufacturing problem in that the closed box section of the parts precludes spot welding assembly techniques. Also, the longitudinal thickness of the hydroformed tube portion between vehicle doors is objectional from a styling standpoint. This design further does not have the desired structure to provide enhanced roof strength over the prior art designs.

Other proposed designs for hydroformed B-pillars are disclosed in published US patent applications US 2004/0239091 A1 and published U.S. patent application US 2005/0023865A1. However, these proposed designs require reinforcing brackets to connect the B-pillar to a roof rail.

### SUMMARY

A vehicle roof support assembly is provided according to the embodiments disclosed herein. The vehicle roof support assembly includes a roof rail, a rocker, a first hollow support member and a second hollow support member. The first hollow support member and the second hollow support member each includes an inner wall, an outer wall, a front wall, a front wall and a rear wall. The first hollow support member and the second hollow support member each include a tubular lower area that extends upwardly from the rocker. The first hollow support member and the second hollow support member also each include an upper section that extends downwardly from the roof rail. The first hollow support member and the second hollow support member are spaced apart from one another and are operatively configured to accommodate a hinge between the first hollow support member and the second hollow support member.

### BRIEF DESCRIPTION OF THE DRAWINGS

The present invention will now be described by way of example, with reference to the accompanying drawings:

FIG. 1 is a partial perspective view of the two hydroformed tubes disposed within the body side inner.

FIG. 2 is a side view of a first embodiment of the dual hydroformed tubes of the present disclosure.

FIG. 3 is a side view of the dual hydroformed tubes and the reinforcement of the present disclosure.

FIG. 4 is a cross sectional view along lines 4-4 in FIG. 3.

FIG. 5A is a first side view of an embodiment of the roof support assembly of the present disclosure.

FIG. 5B is a second side view of an embodiment of the roof support assembly of the present disclosure.

FIG. 5C is an expanded first side view of an embodiment of the roof support assembly of the present disclosure.

FIG. 6 is a cross sectional view along lines 6-6 in FIG. 5A.

FIG. 7 is an expanded partial view of the first and second hollow support members, the pillar reinforcement, body side inner and the rocker reinforcement.

FIG. 8A is a side view of a second embodiment of the dual hydroformed members of the present disclosure.

FIG. 8B is a cross section along lines 8-8 in FIG. 8A.

### DETAILED DESCRIPTION

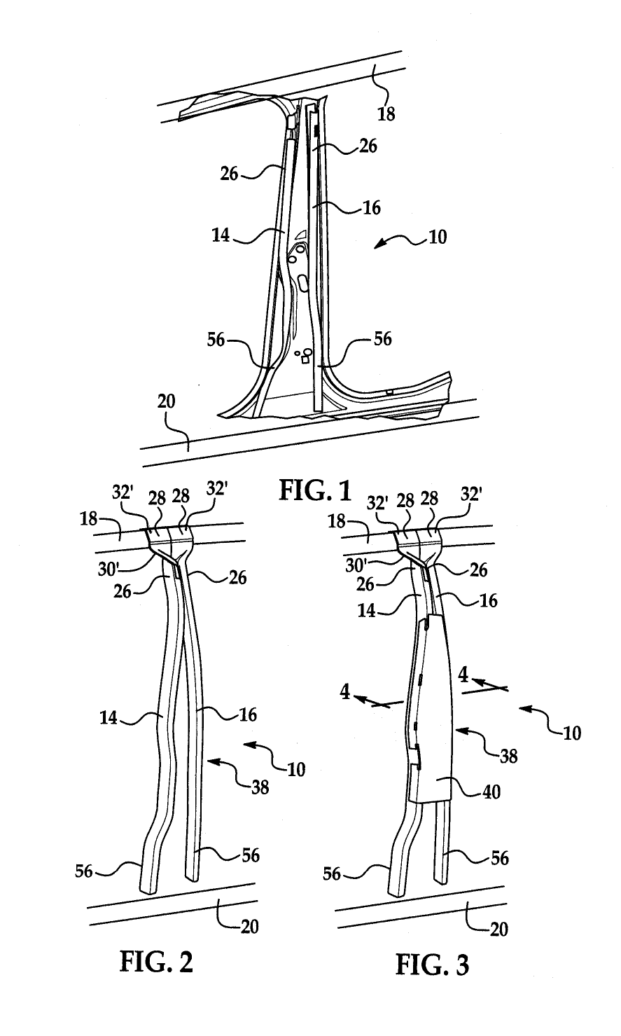

Referring now to the drawings wherein like reference numerals are used to identify identical components in the various views, FIG. 1 illustrates the body side inner panel 12 with the first hollow support member 14 and the second hollow support member 16 disposed within the body side inner panel 12. The body side inner panel 12 may be formed from stamped sheet metal. The first hollow support member 14 and the second hollow support member 16 may be formed into a desired configuration using a hydroforming process. In this non-limiting example, the ends of the first hollow support member 14 and the second hollow support member 16 terminate adjacent to the roof rail 18 at and adjacent to the rocker 20.

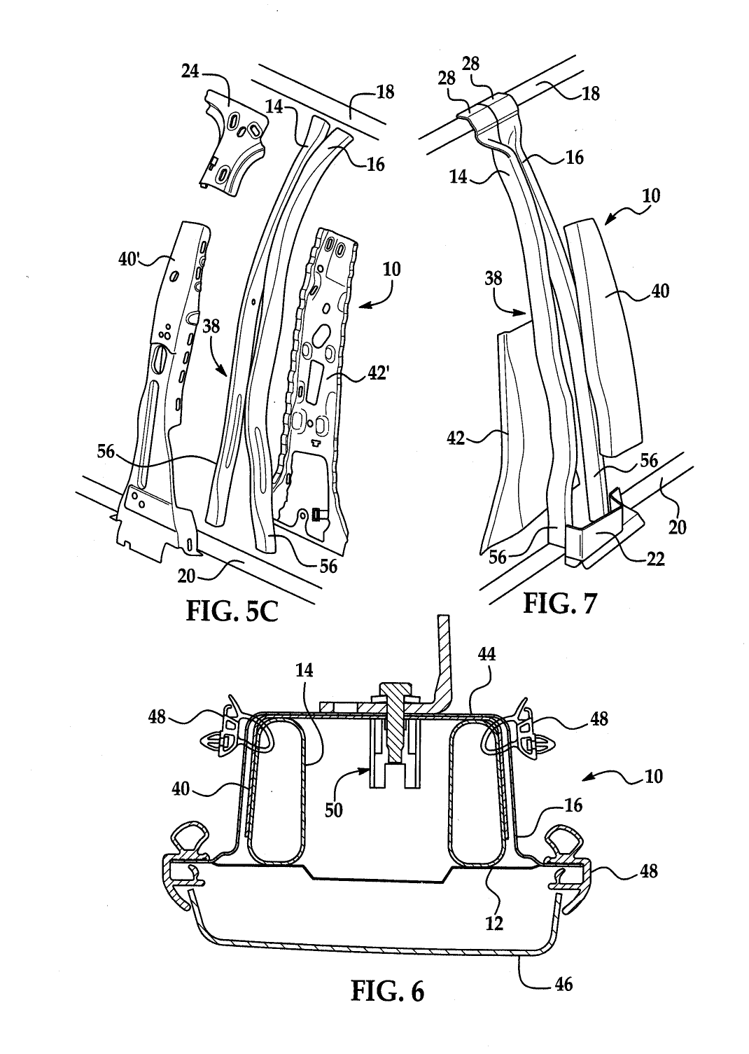

In one embodiment, the ends of the first hollow support member 14 and the second hollow support member 16 terminate adjacent to the roof rail 18 and adjacent to the rocker 20. The first hollow support member 14 and the second hollow support member 16 are each coupled to the rocker 20 and the roof rail 18 using a rocker reinforcement 22 (shown in FIG. 7) and a b-pillar outer bracket 24 (shown in FIG. 5C) respectively.

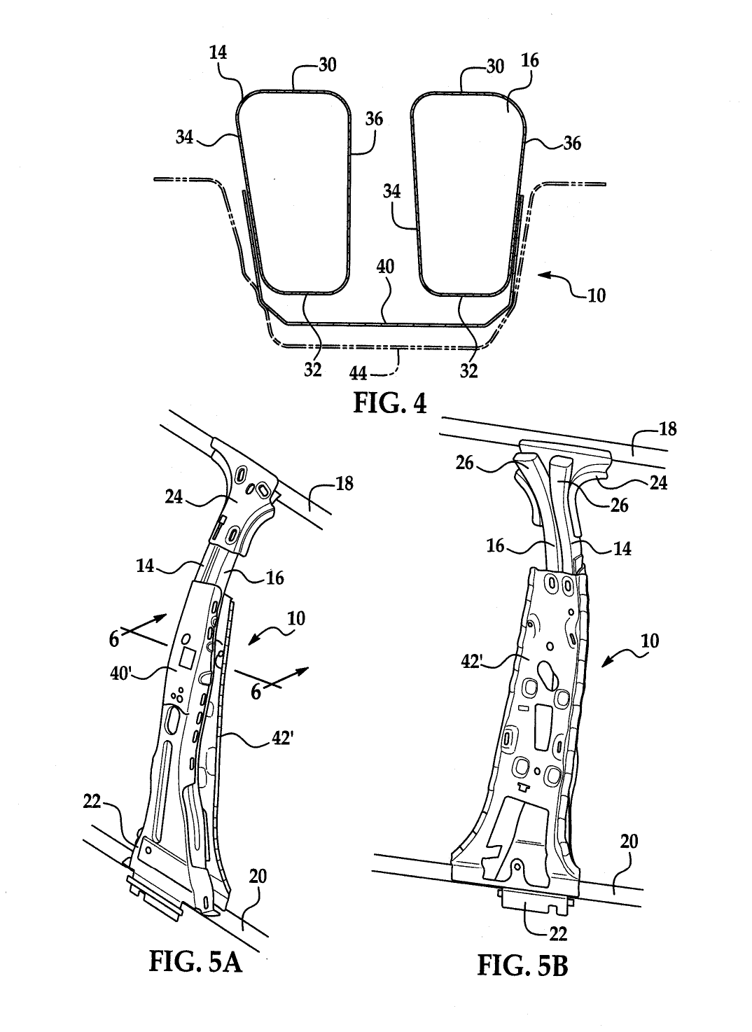

Referring now to FIG. 2, a vehicle roof support assembly 10 may include a roof rail 18, a rocker 20, a first hollow support member 14 and a second hollow support member 16. The first hollow support member 14 and the second hollow support member 16 may each include at least three walls. In the non-limiting example of FIG. 4, an inner wall 30, an outer wall 32, a front wall 34, and a rear wall 36 are illustrated and operatively configured to provided enhanced roof strength to the vehicle.

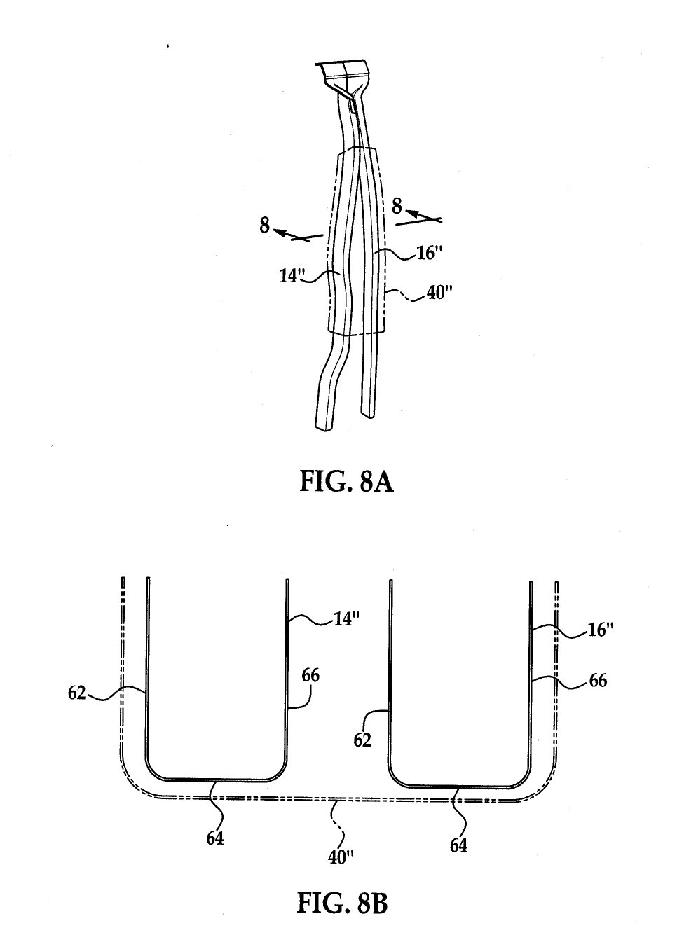

In the non-limiting example of FIGS. 8A and 8B, the first hollow support member 14″ and the second hollow support member 16″ may each have three walls (instead of four walls) wherein the first hollow support member 14″ and the second hollow support member 16″ is an open section. As shown in FIGS. 8A and 8B, a first wall 62, a second wall 64 and a third wall 66 are provided thereby creating an open section. The first wall 62 may be any one of the inner wall 30, outer wall 32, front wall 34 or rear wall 36. The third wall 66 is disposed opposite the first wall 62. The second wall 64 connects the first wall 62 to the third wall 66 as shown in FIG. 8B. In this embodiment, reinforcement 40″″ is shown in phantom.

With reference to FIG. 4, by having two inner walls 30, two outer walls 32, two front walls 34 and 2 rear walls 34, the first hollow support member 14 and the second hollow support member 16 provide added roof support strength. Given their aforementioned configuration, the first hollow support member 14 and the second hollow support member 16 are more resistant to bending. Furthermore, the material gauge for the first and second hollow support members 14, 16 may be reduced relative to traditional tubular support members thereby reducing weight and cost. In one non-limiting example, the first and second hydroformed support members 14, 16 may be formed from 1.66 mm DP780 steel.

As shown in the non-limiting example of FIG. 2, the first and second hollow support members 14, 16 may each include an upper end 26 wherein the upper end 26 is proximate to the roof rail 18. The upper end 26 of each of the first hollow support member 14 and the second hollow support member 16 may be compressed together to form a rail attachment flange 28. The rail attachment flange 28 may then be assembled to an outer surface and an upper surface of the roof rail 18 via a spot welding process or the like. The rail attachment flange 28 includes only an inner wall 30′ and an outer wall 32′.

With reference to FIG. 3, the vehicle roof support assembly 10 may also optionally include a side-impact reinforcement which is disposed along the middle area 38 of the first and second hollow support members 14, 16. Given that the hydroformed tubes may generally have the same gauge thickness throughout, the addition of a side-impact reinforcement provides additional strength and stiffness where such reinforcement is needed in the middle area 38 of the first and second hollow support members 14, 16 in the event of a side impact event.

With reference to FIGS. 5A-5C, another embodiment of the present disclosure is shown where the side impact reinforcement 40′ incorporates a rocker reinforcement 22 such that the side impact reinforcement 40′ extends all the way down to the rocker 20. Moreover, another side impact inner reinforcement may be added to further strengthen the vehicle roof support assembly 10 in the event of a side impact. The side impact reinforcement 40′ and the side impact inner reinforcement 42′ may be affixed to one another or may be affixed to the first and second hydroformed support members 14, 16 using a welding method, mechanical fasters or the like.

Referring now to FIG. 4, a cross sectional view along lines 4-4 in FIG. 3 is shown. The body side outer panel 44 (not shown in FIG. 3) is shown in phantom in FIG. 4. The side impact reinforcement 40 is disposed across the first and second hollow support members and is affixed to the front side of the first hydroformed support member and to the rear side of the second hydroformed support member. As shown in FIG. 4. The side impact reinforcement 40 and the first and second hydroformed support members may be disposed within a recess of the body side outer panel.

Referring now to FIGS. 4 and 6, the first hollow support member 14 and the second hollow support member 16 each include a tubular lower area 56 that extends upwardly from the rocker 20. The first hollow support member 14 and the second hollow support member 16 also each include an upper end 26 that extends downwardly from the roof rail 18. As shown in FIG. 4, the first hollow support member 14 and the second hollow support member 16 are spaced apart from one another in the middle area 38 (shown in FIG. 2) of the first and second hollow support members 14, 16. The first and second hollow support members 14, 16 are operatively configured to accommodate a hinge (shown in FIG. 6) between the first hollow support member 14 and the second hollow support member 16. It is to be understood that the first and second hollow support members 14, 16 may be welded to each other proximate to or at the upper ends 26 of the first and second hollow support members 14, 16 and/or at the tubular lower area 56 of the first and second hollow support members 14, 16.

As further illustrated in FIG. 6, an interior trim component 46 such as but limited to a hard plastic surface may be mounted to the body side inner panel 12. Seals 48 are incorporated at each end of the interior trim component 46 and where the door (not shown) interfaces with the body side outer panel 44 to keep moisture, dirt and noise outside of the vehicle.

Accordingly, the first and second hollow support members 14, 16 are operatively configured to accommodate a wiring harness and a grommet between the first hollow support member 14 and the second hollow support member 16. As shown in FIG. 6, it is also to be understood that a hinge bolt 50 may also be accommodated between the first hollow support member 14 and the second hollow support member 16 as the hinge may be mounted on the body side outer panel.

In yet another embodiment shown in FIGS. 2 and 3, the first and second hollow support members may each include an upper end 26 wherein the upper end 26 is proximate to the roof rail 18. As shown, each upper end 26 may be coupled to the roof rail 18 via the B-Pillar outer bracket 24 (shown in FIGS. 5A-5C).

Similarly, in yet another embodiment, the joining structure of the first and second hollow support members 14, 26 to the rocker 20 may be provided in the form of a rocker reinforcement 22 (FIG. 7). As such, the tubular lower area 56 terminates adjacent to the rocker 20 as shown in FIG. 7 and the rocker reinforcement 22 couples the first and second hollow support members to the rocker 20. The rocker reinforcement 22 may be affixed to the rocker 20 and the first and second hollow support members via a welding process or mechanical fasteners or the like.

Referring to the side impact reinforcements 40 shown in FIGS. 7 and FIGS. 5A-5C, it is to be understood that in one non-limiting example, the side impact reinforcement 40 may be formed from HSLA350 Steel where the thickness can be in the range of 0.5 to 1.0 mm. In yet another non-limiting example, the B-Pillar outer bracket 24 shown in FIGS. 5A-5C and FIG. 7 may also be formed from DP780 steel. The thickness of the B-Pillar outer bracket 24 may range from 1.0 mm to 2.0 mm. Furthermore the rocker reinforcement 22 shown in FIG. 7 may also, but not necessarily be formed from DP780 Steel.

While the best mode for carrying out the invention has been described in detail, those familiar with the art to which this invention relates will recognize various alternative designs and embodiments for practicing the invention as defined by the following claims.

What is claimed is:

1. A vehicle roof support assembly comprising:
a roof rail;
a rocker;
a first hollow support member and a second hollow support member each having at least a first wall, a second wall and a third wall, the first support member and the second hollow support member each having a tubular lower area that extends upwardly from the rocker panel and an upper section that extends downwardly from the roof rail;
wherein the first hollow support member and the second hollow support member are spaced apart from one another in at least a middle area of the first hollow support member and second hollow support member.

2. The vehicle roof support assembly as defined in claim 1 wherein the first hollow support member and the second hollow support member are operatively configured to accommodate a wiring harness and a grommet between the first hollow support member and the second hollow support member, the wiring harness and grommet being affixed to a body side inner panel.

3. The vehicle roof support assembly as defined in claim 1 wherein the first and second hollow support members each having an upper end, the upper end of each of the first hollow support member and the second hollow support member is compressed together and is assembled to an outer surface and an upper surface of the roof rail.

4. The vehicle roof support assembly as defined in claim 1 wherein the tubular lower area terminates in a compressed attachment flange that includes only an inner wall and an outer wall and that is assembled to an outer surface of the rocker panel.

5. The vehicle roof support assembly of claim 2 wherein the rocker attachment flange extends around to the rocker panel.

6. The vehicle roof support assembly of claim 5 wherein the rocker attachment flange is spot welded to the rocker panel.

7. The vehicle roof support assembly as defined in claim 1 wherein each tubular upper section of the first and second hollow support members are coupled to the roof rail via a b-pillar bracket.

8. The vehicle roof support assembly as defined in claim 3 wherein the compressed upper ends of the first hollow support member and the second hollow support member define a rail attachment flange that includes only an inner wall and an outer wall, the rail attachment flange being assembled to an outer surface of the roof rail.

9. The vehicle roof support assembly of claim 8 wherein the compressed rail attachment flange is spot welded to the roof rail.

10. The vehicle roof support assembly of claim 1 further comprising a side reinforcement bracket affixed to the first hollow support member and the second hollow support member.

11. The vehicle roof support assembly of claim 10 further comprising a rocker reinforcement operatively configured to couple the first hollow support member and the second hollow support member to the rocker.

12. The vehicle roof support assembly of claim 1 wherein the first and second hollow support members are welded to one another at the upper section of each the first and second hollow support members.
